(19) United States
(12) Patent Application Publication
(10) Pub. No.: US 2015/0332296 A1
(43) Pub. Date: Nov. 19, 2015

(54) PREDICTING CUSTOMER VALUE

(71) Applicant: International Business Machines Corporation, Armonk, NY (US)

(72) Inventors: Yea Jane Chu, Chicago, IL (US); Mohit Sewak, Lucknow (IN); Jing-Yun Shyr, Naperville, IL (US)

(73) Assignee: International Business Machines Corporation, Armonk, NY (US)

(21) Appl. No.: 14/281,277

(22) Filed: May 19, 2014

(51) Int. Cl. G06Q 30/02

(52) U.S. Cl. CPC G06Q 30/0204

(57) ABSTRACT

In one example, a method includes determining, based on historical purchase data for a customer, an expectancy value that indicates when the customer is expected to make a purchase from a business, determining, based on the historical purchase data for the customer, a frequency value that indicates at what frequency the customer is expected to make purchases from the business during a future time period, and determining, based on the historical purchase data for the customer, a monetary value that indicates how much the customer is expected to spend during the future time period. In this example, the method includes determining, based on the expectancy value, the frequency value, and the monetary value, a future customer value score that indicates how valuable the customer is likely to be in the future time period.

### TECHNICAL FIELD

This disclosure relates to predicting customer value and, more particularly, to determining a future customer value score that indicates how valuable a customer is likely to be in a future time period.

### BACKGROUND

Businesses sell products and services to customers, some of which may be considered to be “better” or more valuable customers than others. In some examples, it may be desirable for a business to quantify the value of its customers. As one example, a business may determine a Recency, Frequency, and Monetary Value (RFM) score for each of its customers that indicates how valuable each customer has been in the past. For instance, a computing device may analyze past purchase data for a particular customer and determine how recently the customer made a purchase (recency, “R”), how often the customer has made purchases (frequency, “F”), and how much the customer spent (monetary value, “M”).

In some examples, it may be desirable for a business to determine how valuable a customer will be in the future. However, a drawback of using an RFM score designed as above is that these scores are based on the aggregation of historical data such as frequency, monetary value and recency values, which as used in the scores, merely reflects the previous purchases.

### SUMMARY

In general, examples disclosed herein are directed to techniques for determining a future customer value score that indicates how valuable a customer is likely to be in a future time period. In this way, a business may determine how valuable a customer will be in the future.

In one example, a method includes determining, by a computing device and based on historical purchase data for a customer, an expectancy value that indicates when the customer is expected to make a purchase from a business, wherein the historical purchase data for the customer comprises a plurality of entries that each corresponds to a purchase made by the customer, wherein each respective entry of the plurality of entries indicates one or more of: a purchase amount, a purchase date, or one or more products. In this example, the method also includes determining, by the computing device and based on the historical purchase data for the customer, a frequency value that indicates at what frequency the customer is expected to make purchases from the business during a future time period. In this example, the method also includes determining, by the computing device and based on the historical purchase data for the customer, a monetary value that indicates how much the customer is expected to spend during the future time period. In this example, the method also includes determining, by the computing device and based on the expectancy value, the frequency value, and the monetary value, a future customer value score that indicates how valuable the customer is likely to be in the future time period.

In another example, a system includes one or more processors, and at least one module executable by the one or more processors. In this example, the at least one module is executable by the one or more processors to determine, based on historical purchase data for a customer, an expectancy value that indicates when the customer is expected to make a purchase from a business, wherein the historical purchase data for the customer comprises a plurality of entries that each corresponds to a purchase made by the customer, wherein each respective entry of the plurality of entries indicates one or more of: a purchase amount, a purchase date, or one or more products. In this example, the at least one module is also executable by the one or more processors to determine, based on the historical purchase data for the customer, a frequency value that indicates at what frequency the customer is expected to make purchases from the business during a future time period. In this example, the at least one module is also executable by the one or more processors to determine, based on the historical purchase data for the customer, a monetary value that indicates how much the customer is expected to spend during the future time period. In this example, the at least one module is also executable by the one or more processors to determine, based on the expectancy value, the frequency value, and the monetary value, a future customer value score that indicates how valuable the customer is likely to be in the future time period.

In another example, a computer program product for predicting customer value includes a computer-readable storage medium having program instructions embodied therewith that are executable by one or more processors to cause the one or more processors to determine, based on historical purchase data for a customer, an expectancy value that indicates when the customer is expected to make a purchase from a business, wherein the historical purchase data for the customer comprises a plurality of entries that each corresponds to a purchase made by the customer, wherein each respective entry of the plurality of entries indicates one or more of: a purchase amount, a purchase date, or one or more products. In this example, the at least one module is also executable by the one or more processors to determine, based on the historical purchase data for the customer, a frequency value that indicates at what frequency the customer is expected to make purchases from the business during a future time period. In this example, the at least one module is also executable by the one or more processors to determine, based on the historical purchase data for the customer, a monetary value that indicates how much the customer is expected to spend during the future time period. In this example, the at least one module is also executable by the one or more processors to determine, based on the expectancy value, the frequency value, and the monetary value, a future customer value score that indicates how valuable the customer is likely to be in the future time period.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram illustrating an example system that is configured to quantify the future value of one or more customers, in accordance with one or more techniques of the present disclosure.

FIG. 2 is a conceptual diagram illustrating an example customer classification system based on a past value of a customer and a future value of the customer, in accordance with one or more techniques of the present disclosure.

FIG. 3 is a flow diagram illustrating example operations of a computing device that quantifies the future value of one or more customers, in accordance with an example of this disclosure.

FIG. 4 is a block diagram of a computing device that may be used quantify the future value of one or more customers, in accordance with an example of this disclosure.

### DETAILED DESCRIPTION

A major drawback of using an RFM score designed as above is that these scores are based on the aggregation of historical data such as frequency, monetary value and recency values as used in the scores, and that these scores just reflect the previous purchases. If one wants to predict the future value, the current RFM score is not optimal be used for this purpose. There is no mechanism to forecast the customer's purchase behavior for the future period as a predictive model might do. Hence a method which can combine forecasting mechanism with the RFM scores has potential to generate high value for any business, such as businesses involved in CRM (Customer Relationship Management), campaign management and e-commence.

Since the customers' transaction data for RFM computation is not regular time series but rather time stamped data, it can't be used to do forecasting directly. A forecasting method, such as Croston's model for the intermittent demand (which uses periods with the demand and intervals between demands to build up the forecast), may be selected to consider two aspects of the transaction data for each customer: the transaction size (purchase amount) and the transaction occurrence (inter-purchase interval). However, there exist some differences between intermittent demand of inventory/order scenarios in the supply chain domain or other slow moving goods, and the product purchases per customer series in retail/CRM/e-commerce scenarios. For instance, Croston's model assumes that the demand size and demand occurrence are independent, so each series is fitted by a simple exponential smoothing model. The independence assumption may not be applicable for transaction data because, in practice, the purchase amount and the inter-purchase interval may be dependent. Additionally, while the objective of forecasting for inventory/orders in Croston's model is to provide a good safety stock, the objectives behind understanding the customers' transaction data are more challenging as they range across not just forecasting the demand of the current product, but also for exploring and optimizing the possibilities of cross-selling and up-selling strategies. Hence, simple exponential smoothing used in Croston's intermittent demand model might not be suitable for the given purpose. Some of the methods given in the disclosure use some modifications of the Croston's intermittent demand model which have been enhanced and customized to better suit the atypical industry transaction and CRM data.

Various examples are disclosed herein for determining a score indicative of a customer's value to a business. In some examples, a computing device may determine a RFM score that indicates how valuable each customer has been in the past. For instance, a computing device may determine a RFM score for a customer by analyzing the customer's historical purchase data to determine an R value, an F value, and an M value for the customer. The computing device may then combine the R value, the F value, and the M value to determine the RFM score for the customer.

In accordance with one or more techniques of this disclosure, the computing device may determine a score that indicates how valuable each customer will be in the future. As one example, a business may determine an Expectancy, Frequency, and Monetary Value (EFM) score for a customer that indicates how valuable the customer will be in the future. For instance, a computing device may analyze past purchase data for a particular customer and determine when the customer is expected to make a purchase (expectancy, “E”), how often the customer is expected to make purchases (frequency, “F”), and how much the customer is expected to spend (monetary value, “M”).

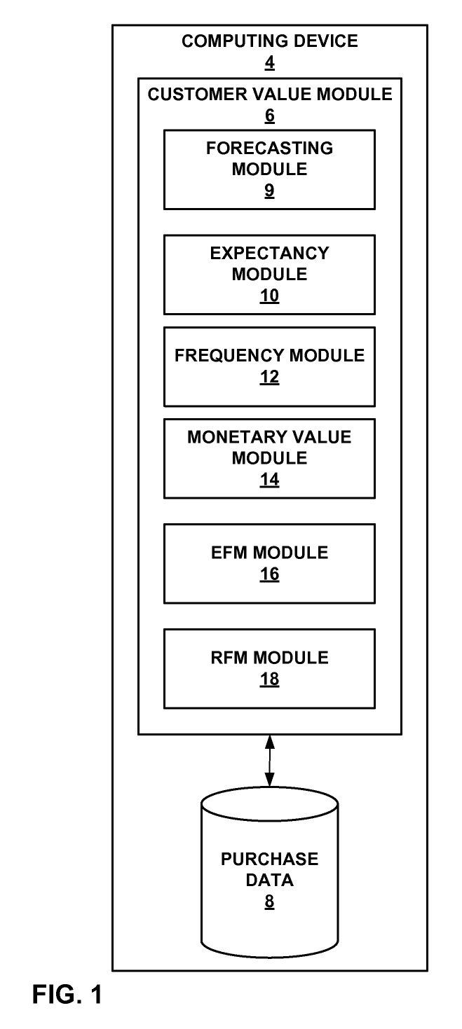

FIG. 1 is a block diagram illustrating example computing device 4 that is configured to determine a value indicative of how valuable a customer will be in the future, in accordance with one or more techniques of the present disclosure. Computing device 4 may operate as all or part of a real or virtual server, and may be or incorporate a workstation, server, mainframe computer, notebook or laptop computer, desktop computer, cash register, tablet, smartphone, feature phone, or other programmable data processing apparatus of any kind Other implementations of a computing device 4 may include a computer having capabilities or formats other than or beyond those described herein. As illustrated in FIG. 1, computing device 4 may include customer value module 6, and purchase data 8.

In some examples, computing device 4 may include customer value module 6 (“CVM 6”), which may be configured to determine a value indicative of how valuable a customer will be in the future. For instance, CVM 6 may determine an EFM score that indicates how valuable a customer will be in the future. In some examples, CVM 6 may be configured to determine a value indicative of how valuable a customer has been in the past. For instance, CVM 6 may determine an RFM score that indicates how valuable a customer has been in the past. As illustrated in FIG. 1, CVM 6 may include forecasting module 9, expectancy module 10, frequency module 12, monetary value module 14, and EFM module 16. In some examples, CVM 6 may also include RFM module 18.

CVM 6, in some examples, may include forecasting module 9 which may be configured to determine one or more future series based on one or more historical series. Forecasting module 9 may be configured to receive the historical series from one or more other components of computing device 4, such as purchase data 8. For instance, forecasting module 9 may include a forecasting engine which may be configured to forecast a predicted inter-purchase series and/or a predicted purchase amount series based on one or both of the historical inter-purchase series and the historical purchase amount series. Forecasting module 9 may be configured to output the future series to one or more other components of computing device 4, such as expectancy module 10, frequency module 12, and/or monetary value module 14.

CVM 6, in some examples, may include expectancy module 10 which may be configured to determine when a customer is expected to make a purchase. For instance, expectancy module 10 may determine an E value that indicates when a customer is expected to make a purchase. In some examples, expectancy module 10 may determine the E value based on historical purchase data, such as historical purchase data received from purchase data 8. Expectancy module 10 may be configured to output the determined E value to one or more components of CVM 6, such as EFM module 16.

CVM 6, in some examples, may include frequency module 12 which may be configured to determine how often the customer is expected to make purchases. For instance, frequency module 12 may determine an F value that indicates how often the customer is expected to make purchases. In some examples, frequency module 12 may determine the F value based on historical purchase data, such as historical purchase data received from purchase data 8. Frequency module 12 may be configured to output the determined F value to one or more components of CVM 6, such as EFM module 16.

CVM 6, in some examples, may include monetary value module 14 which may be configured to determine how much the customer is expected to spend. For instance, monetary value module 14 may determine an M value that indicates how much the customer is expected to spend. In some examples, monetary value module 14 may determine the M value based on historical purchase data, such as historical purchase data received from purchase data 8. Monetary value module 14 may be configured to output the determined M value to one or more components of CVM 6, such as EFM module 16.

CVM 6, in some examples, may include EFM module 16 which may be configured to determine an EFM score that indicates how valuable a customer will be in the future. In some examples, EFM module 16 may determine the EFM score based on an E value received from expectancy module 10, an F value received from frequency module 12, and an M value received from monetary value module 14.

In some examples, computing device 4 may include purchase data 8, which may be configured to store historical purchase data for a plurality of customers and provide the data to other components of computing device 4. For instance, each time a customer makes a purchase, computing device 4 may create an entry in purchase data 8 that indicates the customer, what the customer purchased, how much the customer spent, and when the customer made the purchase.

A business may have a general feeling of which customers are “good” customers and which customers are “bad” customers. However, as opposed to merely a general feeling, a business may desire to quantify the value of one or more of its customers. In accordance with one or more techniques of this disclosure, CVM 6 may determine a customer value that indicates the value of a customer to a business. For instance, CVM 6 may determine a future customer value score that indicates how valuable the customer is likely to be to the business in the future time period. CVM 6 may determine the customer value based on a plurality of scores. For instance, EFM module 16 of CVM 6 may determine an Expectancy Frequency Monetary (EFM) score for a customer based on an Expectancy (E) value determined by expectancy module 10, a Frequency (F) value determined by frequency module 12, and a Monetary (M) value determined by monetary value module 14.

In some examples, expectancy module 10, frequency module 12, and monetary value module 14 may determine their respective values based on historical purchase data received from purchase data 8. In some examples, forecasting module 9 may receive the historical purchase data from purchase data 8, process the data, and provide processed historical purchase data to expectancy module 10, frequency module 12, and monetary value module 14. For instance, upon receiving the purchase data, forecasting module 9 may sort the purchase data by transaction date. In some examples, such as where forecasting module 9 receives purchase data for a plurality of customers, forecasting module 9 may further sort the purchase data by customer identity. Forecasting module 9 may arrange each customer's transaction record (e.g., respective purchase data) in longitudinal order across the active transaction days for each customer.

Forecasting module 9 may extract, for each individual customer, a respective historical purchase amount series from respective historical purchase data. Each respective historical purchase amount series may include a plurality of entries that each indicates a respective historical purchase amount. Forecasting module 9 may extract, for each individual customer, a respective historical inter-purchase series from respective historical purchase data. Each respective historical inter-purchase series may include a plurality of entries that each indicates a time interval between subsequent purchases. In some examples, forecasting module 9 may discard an entry from the historical purchase amount series such that a respective historical purchase amount series and a respective historical inter-purchase series for a particular customer may both include the same number of entries (i.e., forecasting module 9 may make both series the same length for each customer).

Forecasting module 9 may forecast, based on the historical data, one or more future transactions (e.g., future purchase data) with a forecasting model. In some examples, forecasting module 9 may forecast the one or more future transactions within a future time period (e.g., next week, next month, two months from now, next year, etc.). As one example, forecasting module 9 may predict, based on one or both of the historical inter-purchase series for a particular customer and the historical purchase amount series for the particular customer, a predicted inter-purchase series for the particular customer. In some examples, the predicted inter-purchase series comprising a plurality of entries that each indicates a predicted time interval between future subsequent purchases of the particular customer. As another example, forecasting module 9 may predict, based on one or both of the historical inter-purchase series for a particular customer and the historical purchase amount series for the particular customer, a predicted purchase amount series for the particular customer. In some examples, the predicted purchase amount series comprising a plurality of entries that each indicates a predicted purchase amount for a future purchase of the particular customer.

In some examples, forecasting module 9 may be configured to assume that the historical purchase amount series and the historical inter-purchase series are independent when determining the predicted inter-purchase series and the predicted purchase amount series. In some examples, forecasting module 9 may be configured to assume that the historical purchase amount series and the historical inter-purchase series are not independent when determining the predicted inter-purchase series and the predicted purchase amount series. In other words, forecasting module 9 may be configured to use a forecasting model that assumes that the historical purchase amount series and the historical inter-purchase series are correlated.

As one example, forecasting module 9 may use a bivariate time series model, such as bivariate-ARIMA (autoregressive integrated moving average). In some examples, forecasting module 9 may be configured to use a bivariate time series model when the direction of correlation is not known (e.g., when it is not known whether purchase amount influences inter-purchase period, whether inter-purchase interval influences purchase amount, or both).

As another example, forecasting module 9 may use a transfer function model. For instance, forecasting module 9 may be configured to use a transfer function model where it is assumed that inter-purchase interval will affect purchase amount. In such examples, the transfer function model may use purchase amount as a target and inter-purchase interval as a predictor. In some examples, forecasting module 9 may use one or more other predictors in addition to inter-purchase interval. For instance, forecasting module 9 may use one or more promotional events as additional predictors. In some examples, such as where forecasting module 9 is configured to assume that the two series have a contemporaneous relation, forecasting module 9 may be configured to determine the predicted inter-purchase series prior to determining the predicted purchase amount series. For instance, forecasting module 9 may be configured to use a univariate time series module, such as ARIMA or exponential smoothing, to determine the predicted inter-purchase series and then use predicted inter-purchase series to determine the predicted purchase amount series. In some examples, forecasting module 9 may include and/or use one or more neural networks and one or more machine learning algorithms (which may be capable of predicting complex relationships) to determine one or both of the predicted inter-purchase series and/or the predicted purchase amount series.

Forecasting module 9 may be configured to determine the future purchase data based on the predicted inter-purchase series and the predicted purchase amount series. For instance, forecasting module 9 may integrate the predicted inter-purchase series and the predicted purchase amount series to obtain forecasted future purchase data for each customer, such as by using an arithmetic progression to determine the future purchase dates by adding the inter-purchase intervals to the last available transaction date. In some examples, forecasting module 9 may be configured to determine whether or not the forecasted data is reliable. For instance, forecasting module 9 may be configured to determine whether or not the series include enough entries to make the forecasts reliable. Forecasting module 9 may provide the determined future purchase data to expectancy module 10, frequency module 12, and monetary value module 14.

Expectancy module 10 may receive the future purchase data and determine, for each customer, a respective E value that indicates when the respective customer is expected to make a purchase from a business. For instance, expectancy module 10 may determine the E value for a particular customer as a difference in days between a current date and a time indicated by a particular entry of the future purchase data for the particular customer that indicates the earliest purchase date within a future time period. Expectancy module 10 may provide the determined E values to EFM module 16. In some examples, expectancy module 10 may sort all the determined E values (e.g., in ascending order) prior to providing the values to EFM module 16.

Frequency module 12 may receive the future purchase data and determine, for each customer, a respective F value that indicates at what frequency the respective customer is expected to make purchases from the business during the future time period. For instance, frequency module 12 may determine the F value for a particular customer as a quantity of entries of the future purchase data for the respective customer that indicates purchase dates within the future time period. Frequency module 12 may provide the determined F values to EFM module 16. In some examples, frequency module 12 may sort all the determined F values (e.g., in descending order) prior to providing the values to EFM module 16.

Monetary value module 14 may receive the future purchase data and determine, for each customer, a respective M value that indicates how much the respective customer is expected to spend during the future time period. For instance, monetary value module 14 may determine the M value for a particular customer as a sum of the purchase amounts indicated by entries of the future purchase data for the respective customer that indicate purchase dates within the future time period. Monetary value module 14 may provide the determined M values to EFM module 16. In some examples, monetary value module 14 may sort all the determined M values (e.g., in descending order) prior to providing the values to EFM module 16.

EFM module 16 may determine, for each customer, a respective EFM value that indicates how valuable each respective customer is likely to be in the future time period based on the respective E value, the respective F value, and the respective M value. In some examples, EFM module 16 may bin the respective values. For instance, EFM module 16 may bin the E values into quartiles, quintiles, deciles, etc. with approximately an equal quantity of values in each bin (e.g., if there are 100 customers and EFM module 16 bins into quartiles, each bin will have ˜25 values). EFM module 16 may assign each bin a score. For instance, the lowest quintile (e.g., the bin with the lowest values) may be assigned a score of 1 and the highest quintile (e.g., the bin with the highest values) may be assigned a score of 5. In some examples, EFM module 16 may determine the EFM value for a customer based on the binned scores of the customer's respective E, F, and M values. For instance, if the customer's E value is in the lowest quintile (e.g., with a score of 1), the customer's F value is in the highest quintile (e.g., with a score of 5), and the customer's M value is in the second highest quintile (e.g., with a score of 4), EFM module 16 may determine that the customer has a respective EFM score of 10 (e.g., 1+5+4). In some examples, EFM module 16 may apply one or more weighting values to the bins. For instance, EFM module 16 may apply a weighting value of 100 of the E values, a weighting value of 10 to the F values, and a weighting value of 1 to the M values. Applying said weighting values to the above example (where the customer's E value had a score of 1, the customer's F value had a score of 5, and the customer's M value had a score of 4), EFM module 16 may determine that the customer has a respective weighted EFM score of 154 (e.g., 100*1+10*5+1*4). In this way, EFM module 16 may quantify the value of one or more of its customers.

In some examples, as opposed to computing an overall EFM score that indicates how valuable the customer is likely to be in the future time period, EFM module 16 may determine a customized EFM (c-EFM) score that indicates how valuable the customer is likely to be in a future time period with respect to a particular product or product category (e.g., food, apparel, appliances, etc.). In some examples, each customer may have a different c-EFM score for each product or product category which may be different from their overall EFM score. While designing any cross product promotions like cross-selling, up-selling campaigns the overall EFM scores might be used, but for other general promotion programs within a particular product or product category, using these c-EFM scores for specific products or product categories might prove more optimal.

In some examples, EFM module 16 may determine, for a particular customer, a predicted next purchase date, and a predicted next purchase amount. In some examples, EFM module 16 may derive the next purchase date by adding the one-step-ahead forecast for inter-purchase interval series to the last available transaction date. This information and the corresponding purchase amount (one-step-ahead forecast for purchase amount) may be of great use out of those forecasts of two series for some specific campaigns and use-cases to ascertain when the customer is most likely going to make their next purchase and what the most likely purchase amount will be.

In some examples, in addition to quantifying the future value of one or more of its customers, a business may desire to quantify the past value of one or more of its customers. As such, the business may provide input to computing device 4 that causes RFM module 18 of computing device 4 to determine a past customer value score (e.g., an RFM score) that indicates how valuable a customer was during the past time period. The past customer value score differs from the future customer value score in that the future customer value score is determined entirely from forecasted data (e.g., looking forward) and the past customer value score is determined entirely from historical data (e.g., looking backward).

RFM module 18 may determine the past customer value score for a particular customer of the plurality of customers by determining, based on historical purchase data for the particular customer, a past recency (R) value, a past frequency (F) value, and a past monetary (M) value. The past recency value may indicate how much time has elapsed since the customer last made a purchase from the business. The past frequency value may indicate at what frequency the customer made purchases from the business during a past time period. The past monetary value may indicate how much the customer spent during the past time period. RFM module 18 may determine the RFM score for the customer using a similar method to the method that EFM module 16 uses to determine the EFM score. For instance, RFM module 18 may bin the respective R, F, and M values, and/or weight the respective R, F, and M values.

In some examples, CVM 6 may perform analysis based on one or both of the future customer values (EFM) and the past customer values (RFM). For instance, a company desires a reliable forward looking segmentation strategy to partition its customers on the basis of their likely future transactions as well as their past transactions. In some examples, to achieve this objective, the company may provide input to computing device 4 that causes computing device 4 to use the EFM score as an attribute of a customer when performing customer segmentation or clustering analysis to understand the consumption behavior of different groups of customers. In some examples, computing device 4 may combine the RFM and EFM scores to categorize the customers into different groups. For instance, CVM 6 may categorize each customer by comparing their respective EFM score to an EFM threshold and comparing their respective RFM score to an RFM threshold.

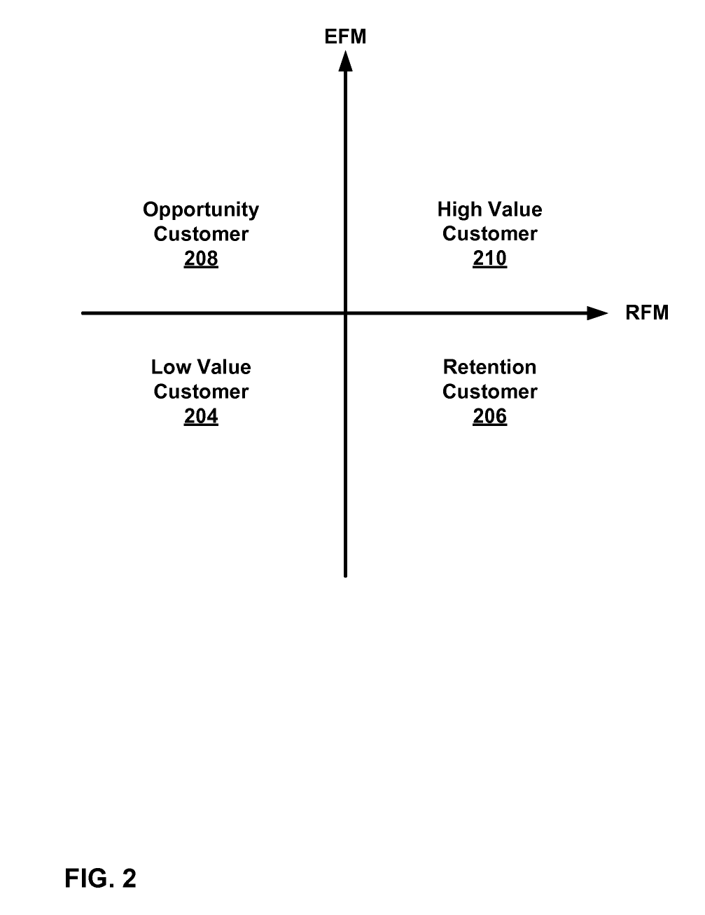

FIG. 2 is a conceptual diagram illustrating an example customer classification system based on a past value of a customer and a future value of the customer, in accordance with one or more techniques of the present disclosure. The customer classification system of FIG. 2 may be performed by a computing device, such as computing device 4 illustrated in FIG. 1. For purposes of illustration, the customer classification system of FIG. 2 is described within the context of computing device 4 of FIG. 1, although computing devices having configurations different than that of computing device 4 may perform the customer classification system of FIG. 2.

As one example, responsive to determining that a past customer value score for the customer does not satisfy the RFM threshold and that the future customer value score for the customer does not satisfy a EFM threshold, CMV 6 may categorize the customer as a low value customer 204. As another example, responsive to determining that a past customer value score for the customer satisfies the RFM threshold and that the future customer value score for the customer does not satisfy the EFM threshold, CMV 6 may categorize the customer as a retention customer 206. As another example, responsive to determining that a past customer value score for the customer does not satisfy the RFM threshold and that the future customer value score for the customer satisfies the EFM threshold, CMV 6 may categorize the customer as an opportunity customer 208. As another example, responsive to determining that a past customer value score for the customer satisfies the RFM threshold and that the future customer value score for the customer satisfies the EFM threshold, CMV 6 may categorize the customer as a high value customer 210.

Different marketing strategies may be used for each group. As one example, there may be an upward trend for the customers classified as opportunity customers 208 and the company may design marketing campaigns to get as much value as possible for the opportunity customers 208. As another example, there may be a downward trend for the customers classified as retention customers 206 and the company may design marketing campaigns to keep such customers purchasing.

Referring again to FIG. 1, a company may further use the RFM and EFM scores to reduce customer churn. As such, a company may use computing device 4 to predict which customers are likely to churn such that the company may design campaigns to check the attrition of such customers. In some examples, CVM 6 may predict that customers with high RFM scores and low EFM scores are likely to churn. CVM 6 may determine, for a particular customer predicted to churn, a product that the customer is most likely to purchase next, a price that the customer would pay for the determined product, and a time when the customer is likely to purchase the determined product at the determined price. In some examples, CVM 6 may determine the product that is most likely to be purchased next using customer segment and previously purchased product/category using association rule or market basket analysis (MBA) algorithm. In some examples, CVM 6 may determine the price that the customer would pay for the determined product as the forecasted next purchase amount. In some examples, CVM 6 may determine the time when the customer is likely to purchase the determined product at the determined price as the forecasted next purchase date.

A company may desire to run a “product of the month” promotional campaign. In accordance with one or more techniques of this disclosure, CVM 6 may determine, based on historical purchase data received from purchase data 8, a particular product to be used for the promotional campaign. CVM 6 may select the product by determining which customers of the plurality of customers are likely to purchase each product of a plurality of products, determining a total amount that the plurality of customers is likely to spend on each product of the plurality of products, and identifying a particular product of the plurality of products with the highest respective total amount as the product to be used in the promotional campaign.

The company may send out the promotional papers or messages to those customers identified as likely to purchase the selected product. In some examples, the company can use the c-EFM scores for the selected product to rank the customers for this campaign then send out the promotional materials to those customers with c-EFM scores for the selected product above a threshold.

In some examples, to further enhance the campaign to optimize the cross-sell potential, computing device 4 can use association rule algorithms to find the potential cross-sell products associated with the selected product. Then computing device 4 can compute the weighted c-EFM scores for the select “Product of the Month” and those potential cross-sell products. Finally, the weighted c-EFM scores can be used in conjunction with the c-EFM scores for the select product.

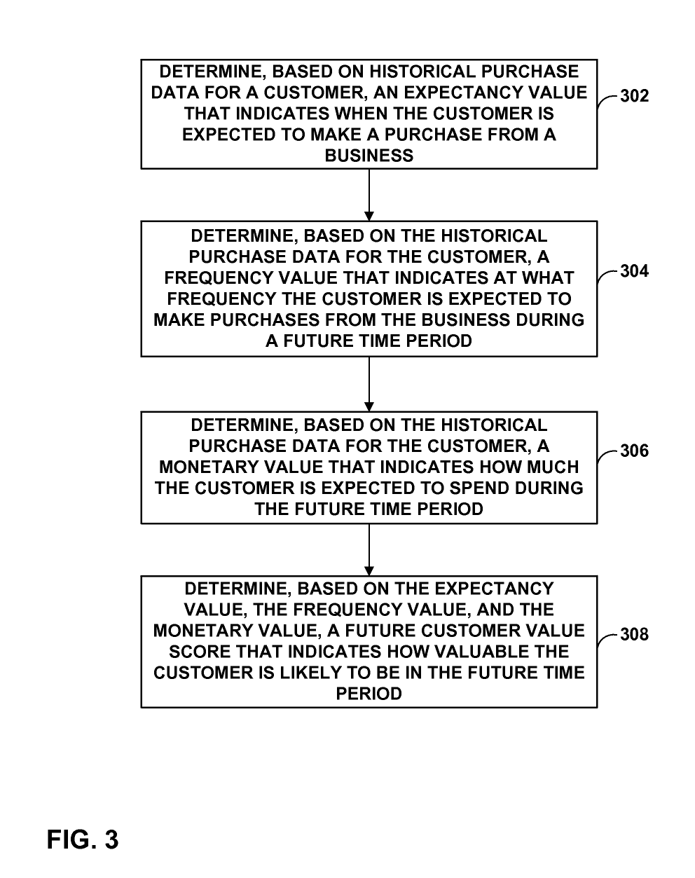

FIG. 3 is a flow diagram illustrating example operations of a computing device that quantifies the future value of one or more customers, in accordance with an example of this disclosure. The techniques of FIG. 3 may be performed by one or more processors of a computing device, such as computing device 4 illustrated in FIG. 1. For purposes of illustration, the techniques of FIG. 3 are described within the context of computing device 4 of FIG. 1, although computing devices having configurations different than that of computing device 4 may perform the techniques of FIG. 3.

In accordance with one or more techniques of this disclosure, expectancy module 10 of CVM 6 of computing device 4 may determine, based on historical purchase data for a customer, an expectancy value that indicates when the customer is expected to make a purchase from a business (302). As discussed above, in some examples, expectancy module 10 may determine the expectancy value based on future purchase data received from forecasting module 9. Also as discussed above, forecasting module 9 may receive historical purchase data from purchase data 8, process the purchase data to forecast a predicted inter-purchase interval series and a predicted purchase amount series, and determine the future purchase data based on the predicted inter-purchase interval series and the predicted purchase amount series.

Frequency module 12 of CVM 6 may determine, based on the historical purchase data for the customer, a frequency value that indicates at what frequency the customer is expected to make purchases from the business during a future time period (304). As discussed above, in some examples, frequency module 12 may determine the frequency value based on future purchase data received from forecasting module 9.

Monetary value module 14 of CVM 6 may determine, based on the historical purchase data for the customer, a monetary value that indicates how much the customer is expected to spend during the future time period (306). As discussed above, in some examples, monetary value module 14 may determine the monetary value based on future purchase data received from forecasting module 9.

EFM module 16 of CVM 6 may determine, based on the expectancy value, the frequency value, and the monetary value, a future customer value score that indicates how valuable the customer is likely to be in the future time period (308). As discussed above, in some examples, EFM module 16 may bin and/or weight the expectancy value, the frequency value, and the monetary value, to determine the future customer value score.

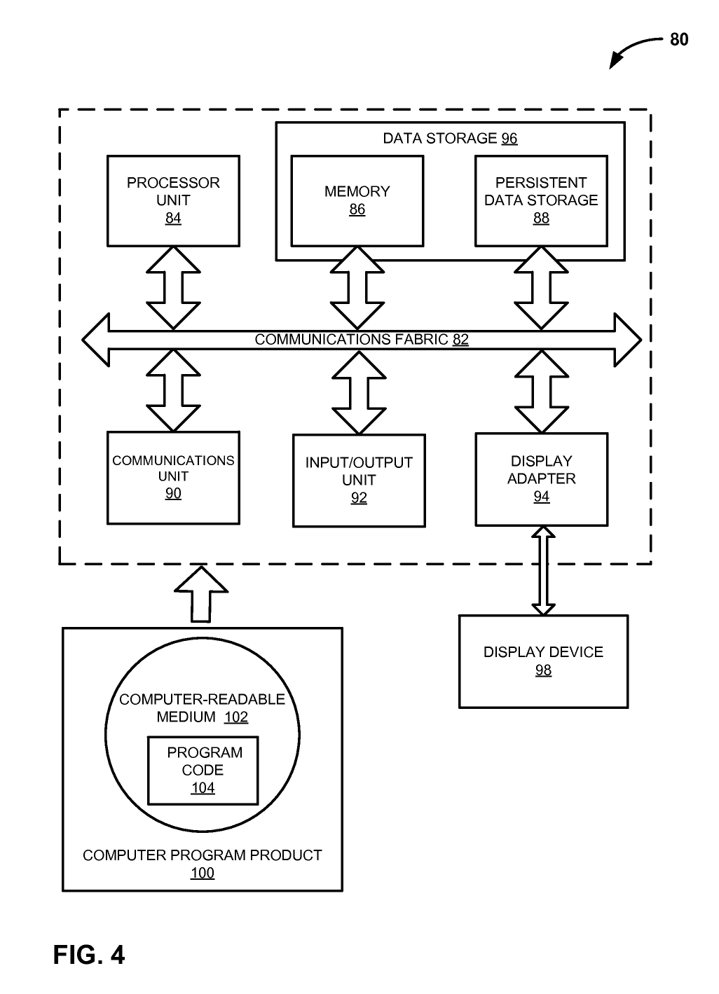

FIG. 4 is a block diagram of a computing device 80 that may be used quantify the future value of one or more customers, in accordance with an example of this disclosure. Computing device 80 may be an example of computing device 4 as depicted in FIG. 1. Computing device 80 may also be any server for providing an enterprise business intelligence application in various examples, including a virtual server that may be run from or incorporate any number of computing devices. A computing device may operate as all or part of a real or virtual server, and may be or incorporate a workstation, server, mainframe computer, notebook or laptop computer, desktop computer, tablet, smartphone, feature phone, or other programmable data processing apparatus of any kind Other implementations of a computing device 80 may include a computer having capabilities or formats other than or beyond those described herein.

In the illustrative example of FIG. 4, computing device 80 includes communications fabric 82, which provides communications between processor unit 84, memory 86, persistent data storage 88, communications unit 90, and input/output (I/O) unit 92. Communications fabric 82 may include a dedicated system bus, a general system bus, multiple buses arranged in hierarchical form, any other type of bus, bus network, switch fabric, or other interconnection technology. Communications fabric 82 supports transfer of data, commands, and other information between various subsystems of computing device 80.

Processor unit 84 may be a programmable central processing unit (CPU) configured for executing programmed instructions stored in memory 86. In another illustrative example, processor unit 84 may be implemented using one or more heterogeneous processor systems in which a main processor is present with secondary processors on a single chip. In yet another illustrative example, processor unit 84 may be a symmetric multi-processor system containing multiple processors of the same type. Processor unit 84 may be a reduced instruction set computing (RISC) microprocessor such as a PowerPC® processor from IBM® Corporation, an x86 compatible processor such as a Pentium® processor from Intel® Corporation, an Athlon® processor from Advanced Micro Devices® Corporation, or any other suitable processor. In various examples, processor unit 84 may include a multi-core processor, such as a dual core or quad core processor, for example. Processor unit 84 may include multiple processing chips on one die, and/or multiple dies on one package or substrate, for example. Processor unit 84 may also include one or more levels of integrated cache memory, for example. In various examples, processor unit 84 may comprise one or more CPUs distributed across one or more locations.

Data storage 96 includes memory 86 and persistent data storage 88, which are in communication with processor unit 84 through communications fabric 82. Memory 86 can include a random access semiconductor memory (RAM) for storing application data, i.e., computer program data, for processing. While memory 86 is depicted conceptually as a single monolithic entity, in various examples, memory 86 may be arranged in a hierarchy of caches and in other memory devices, in a single physical location, or distributed across a plurality of physical systems in various forms. While memory 86 is depicted physically separated from processor unit 84 and other elements of computing device 80, memory 86 may refer equivalently to any intermediate or cache memory at any location throughout computing device 80, including cache memory proximate to or integrated with processor unit 84 or individual cores of processor unit 84.

Persistent data storage 88 may include one or more hard disc drives, solid state drives, flash drives, rewritable optical disc drives, magnetic tape drives, or any combination of these or other data storage media. Persistent data storage 88 may store computer-executable instructions or computer-readable program code for an operating system, application files comprising program code, data structures or data files, and any other type of data. These computer-executable instructions may be loaded from persistent data storage 88 into memory 86 to be read and executed by processor unit 84 or other processors. Data storage 96 may also include any other hardware elements capable of storing information, such as, for example and without limitation, data, program code in functional form, and/or other suitable information, either on a temporary basis and/or a permanent basis.

Persistent data storage 88 and memory 86 are examples of physical, tangible, non-transitory computer-readable data storage devices. Data storage 96 may include any of various forms of volatile memory that may require being periodically electrically refreshed to maintain data in memory, while those skilled in the art will recognize that this also constitutes an example of a physical, tangible, non-transitory computer-readable data storage device. Executable instructions may be stored on a non-transitory medium when program code is loaded, stored, relayed, buffered, or cached on a non-transitory physical medium or device, including if only for only a short duration or only in a volatile memory format.

Processor unit 84 can also be suitably programmed to read, load, and execute computer-executable instructions or computer-readable program code for a cache sync manager 22, as described in greater detail above. This program code may be stored on memory 86, persistent data storage 88, or elsewhere in computing device 80. This program code may also take the form of program code 104 stored on computer-readable medium 102 (e.g., a computer-readable storage medium) comprised in computer program product 100, and may be transferred or communicated, through any of a variety of local or remote means, from computer program product 100 to computing device 80 to be enabled to be executed by processor unit 84, as further explained below.

The operating system may provide functions such as device interface management, memory management, and multiple task management. The operating system can be a Unix based operating system such as the AIX® operating system from IBM® Corporation, a non-Unix based operating system such as the Windows® family of operating systems from Microsoft® Corporation, a network operating system such as JavaOS® from Oracle® Corporation, or any other suitable operating system. Processor unit 84 can be suitably programmed to read, load, and execute instructions of the operating system.

Communications unit 90, in this example, provides for communications with other computing or communications systems or devices. Communications unit 90 may provide communications through the use of physical and/or wireless communications links. Communications unit 90 may include a network interface card for interfacing with a LAN 16, an Ethernet adapter, a Token Ring adapter, a modem for connecting to a transmission system such as a telephone line, or any other type of communication interface. Communications unit 90 can be used for operationally connecting many types of peripheral computing devices to computing device 80, such as printers, bus adapters, and other computers. Communications unit 90 may be implemented as an expansion card or be built into a motherboard, for example.

The input/output unit 92 can support devices suited for input and output of data with other devices that may be connected to computing device 80, such as keyboard, a mouse or other pointer, a touchscreen interface, an interface for a printer or any other peripheral device, a removable magnetic or optical disc drive (including CD-ROM, DVD-ROM, or Blu-Ray), a universal serial bus (USB) receptacle, or any other type of input and/or output device. Input/output unit 92 may also include any type of interface for video output in any type of video output protocol and any type of monitor or other video display technology, in various examples. It will be understood that some of these examples may overlap with each other, or with example components of communications unit 90 or data storage 96. Input/output unit 92 may also include appropriate device drivers for any type of external device, or such device drivers may reside elsewhere on computing device 80 as appropriate.

Computing device 80 also includes a display adapter 94 in this illustrative example, which provides one or more connections for one or more display devices, such as display device 98, which may include any of a variety of types of display devices. It will be understood that some of these examples may overlap with example components of communications unit 90 or input/output unit 92. Input/output unit 92 may also include appropriate device drivers for any type of external device, or such device drivers may reside elsewhere on computing device 80 as appropriate. Display adapter 94 may include one or more video cards, one or more graphics processing units (GPUs), one or more video-capable connection ports, or any other type of data connector capable of communicating video data, in various examples. Display device 98 may be any kind of video display device, such as a monitor, a television, or a projector, in various examples.

Input/output unit 92 may include a drive, socket, or outlet for receiving computer program product 100, which comprises a computer-readable medium 102 having computer program code 104 stored thereon. For example, computer program product 100 may be a CD-ROM, a DVD-ROM, a Blu-Ray disc, a magnetic disc, a USB stick, a flash drive, or an external hard disc drive, as illustrative examples, or any other suitable data storage technology.

Computer-readable medium 102 may include any type of optical, magnetic, or other physical medium that physically encodes program code 104 as a binary series of different physical states in each unit of memory that, when read by computing device 80, induces a physical signal that is read by processor 84 that corresponds to the physical states of the basic data storage elements of computer-readable medium 102, and that induces corresponding changes in the physical state of processor unit 84. That physical program code signal may be modeled or conceptualized as computer-readable instructions at any of various levels of abstraction, such as a high-level programming language, assembly language, or machine language, but ultimately constitutes a series of physical electrical and/or magnetic interactions that physically induce a change in the physical state of processor unit 84, thereby physically causing or configuring processor unit 84 to generate physical outputs that correspond to the computer-executable instructions, in a way that causes computing device 80 to physically assume new capabilities that it did not have until its physical state was changed by loading the executable instructions comprised in program code 104.

In some illustrative examples, program code 104 may be downloaded over a network to data storage 96 from another device or computer system for use within computing device 80. Program code 104 comprising computer-executable instructions may be communicated or transferred to computing device 80 from computer-readable medium 102 through a hard-line or wireless communications link to communications unit 90 and/or through a connection to input/output unit 92. Computer-readable medium 102 comprising program code 104 may be located at a separate or remote location from computing device 80, and may be located anywhere, including at any remote geographical location anywhere in the world, and may relay program code 104 to computing device 80 over any type of one or more communication links, such as the Internet and/or other packet data networks. The program code 104 may be transmitted over a wireless Internet connection, or over a shorter-range direct wireless connection such as wireless LAN, Bluetooth™, Wi-Fi™, or an infrared connection, for example. Any other wireless or remote communication protocol may also be used in other implementations.

The communications link and/or the connection may include wired and/or wireless connections in various illustrative examples, and program code 104 may be transmitted from a source computer-readable medium 102 over non-tangible media, such as communications links or wireless transmissions containing the program code 104. Program code 104 may be more or less temporarily or durably stored on any number of intermediate tangible, physical computer-readable devices and media, such as any number of physical buffers, caches, main memory, or data storage components of servers, gateways, network nodes, mobility management entities, or other network assets, en route from its original source medium to computing device 80.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The description of the present disclosure has been presented for purposes of illustration and description, and is not intended to be exhaustive or limited to the disclosure in the form disclosed. Many modifications and variations will be understood by persons of ordinary skill in the art based on the concepts disclosed herein. The particular examples described were chosen and disclosed in order to explain the principles of the disclosure and example practical applications, and to enable others of ordinary skill in the art to understand the disclosure for various embodiments with various modifications as are suited to the particular use contemplated. The various examples described herein and other embodiments are within the scope of the following claims.

1-11. (canceled)

12. A system comprising:
one or more processors; and
at least one module executable by the one or more processors to:
determine, based on historical purchase data for a customer, an expectancy value that indicates when the customer is expected to make a purchase from a business, wherein the historical purchase data for the customer comprises a plurality of entries that each corresponds to a purchase made by the customer, and wherein each respective entry of the plurality of entries indicates one or more of: a purchase amount, a purchase date, or one or more products;
determine, based on the historical purchase data for the customer, a frequency value that indicates at what frequency the customer is expected to make purchases from the business during a future time period;
determine, based on the historical purchase data for the customer, a monetary value that indicates how much the customer is expected to spend during the future time period; and
determine, based on the expectancy value, the frequency value, and the monetary value, a future customer value score that indicates how valuable the customer is likely to be in the future time period.

13. The system of claim 12, wherein the at least one module is further executable by the one or more processors to:
determine, based on the historical purchase data for the customer, a historical inter-purchase series comprising a plurality of entries that each indicate a time interval between subsequent historical purchases;
determine, based on the historical purchase data for the customer, a historical purchase amount series comprising a plurality of entries that each indicate a respective historical purchase amount;
forecast, by a forecasting engine and based on one or both of the historical inter-purchase series and the historical purchase amount series, a predicted inter-purchase series comprising a plurality of entries that each indicate a predicted time interval between subsequent future purchases;
forecast, by a forecasting engine and based on one or both of the historical inter-purchase series and the historical purchase amount series, a predicted purchase amount series comprising a plurality of entries that each indicate a predicted purchase amount for a future purchase; and
determine, based on the predicted inter-purchase series and the predicted purchase amount series, future purchase data for the customer, wherein the future purchase data for the customer comprises one or more entries that each corresponds to a purchase predicted to be made by the customer, wherein each respective entry of the one or more entries indicates one or more of: a purchase amount, a purchase date, or one or more products.

14. The system of claim 13,
wherein determining the expectancy value comprises determining a difference between a current time and a time indicated by a particular entry of the future purchase data that indicates an earliest purchase date within the future time period,
wherein determining the frequency value comprises determining a quantity of entries of the future purchase data that indicate purchase dates within the future time period, and
wherein determining the monetary value comprises determining a sum of the purchase amounts indicated by entries of the future purchase data that indicate purchase dates within the future time period.

15. The system of claim 12, wherein the at least one module is further executable by the one or more processors to:
in response to determining that a past customer value score for the customer does not satisfy a first threshold and that the future customer value score for the customer does not satisfy a second threshold, categorize the customer as a low value customer;
in response to determining that a past customer value score for the customer satisfies the first threshold and that the future customer value score for the customer does not satisfy the second threshold, categorize the customer as a retention customer;
in response to determining that a past customer value score for the customer does not satisfy the first threshold and that the future customer value score for the customer satisfies the second threshold, categorize the customer as an opportunity customer; and
in response to determining that a past customer value score for the customer satisfies the first threshold and that the future customer value score for the customer satisfies the second threshold, categorize the customer as a high value customer.

16. The system of claim 15, wherein the at least one module is further executable by the one or more processors to:
responsive to categorizing the customer as a retention customer:
determine, based on the historical purchase data, a product that is most likely to be purchased next by the customer;
determine, based on the historical purchase data, a price that the customer would pay for the determined product; and
determine, based on the historical purchase data, a time when the customer is likely to purchase the determined product at the determined price.

17. The system of claim 12, wherein the customer is a particular customer of a plurality of customers, wherein determining the future customer value score comprises determining, based on respective historical purchase data for a particular customer of the plurality of customers, a respective future customer value score for each customer of the plurality of customers, and wherein the at least one module is further executable by the one or more processors to:
determine which customers of the plurality of customers are likely to purchase each product of a plurality of products;
determine a total amount that the plurality of customers is likely to spend on each product of the plurality of products; and
identify a particular product of the plurality of products with the highest respective total amount as a special product.

18. A computer program product for predicting customer value, the computer program product comprising a computer-readable storage medium having program instructions embodied therewith, the program instructions executable by one or more processors to cause the one or more processors to:
determine, based on historical purchase data for a customer, an expectancy value that indicates when the customer is expected to make a purchase from a business, wherein the historical purchase data for the customer comprises a plurality of entries that each corresponds to a purchase made by the customer, and wherein each respective entry of the plurality of entries indicates one or more of: a purchase amount, a purchase date, or one or more products;
determine, based on the historical purchase data for the customer, a frequency value that indicates at what frequency the customer is expected to make purchases from the business during a future time period;
determine, based on the historical purchase data for the customer, a monetary value that indicates how much the customer is expected to spend during the future time period; and
determine, based on the expectancy value, the frequency value, and the monetary value, a future customer value score that indicates how valuable the customer is likely to be in the future time period.

19. The computer program product of claim 18, wherein the program instructions are further executable by the one or more processors to cause the one or more processors to:
determine, based on the historical purchase data for the customer, a historical inter-purchase series comprising a plurality of entries that each indicate a time interval between subsequent historical purchases;
determine, based on the historical purchase data for the customer, a historical purchase amount series comprising a plurality of entries that each indicate a respective historical purchase amount;
forecast, by a forecasting engine and based on one or both of the historical inter-purchase series and the historical purchase amount series, a predicted inter-purchase series comprising a plurality of entries that each indicate a predicted time interval between subsequent future purchases;
forecast, by a forecasting engine and based on one or both of the historical inter-purchase series and the historical purchase amount series, a predicted purchase amount series comprising a plurality of entries that each indicate a predicted purchase amount for a future purchase; and
determine, based on the predicted inter-purchase series and the predicted purchase amount series, future purchase data for the customer, wherein the future purchase data for the customer comprises one or more entries that each corresponds to a purchase predicted to be made by the customer, wherein each respective entry of the one or more entries indicates one or more of: a purchase amount, a purchase date, or one or more products.

20. The computer-readable storage medium of claim 19,
wherein the program instructions that are executable by the one or more processors to cause the one or more processors to determine the expectancy value comprise instructions that cause the one or more processors to determine a difference between a current time and a time indicated by a particular entry of the future purchase data that indicates an earliest purchase date within the future time period,
wherein the program instructions that are executable by the one or more processors to cause the one or more processors to determine the frequency value comprise instructions that cause the one or more processors to determine a quantity of entries of the future purchase data that indicate purchase dates within the future time period, and
wherein the program instructions that are executable by the one or more processors to cause the one or more processors to determine the monetary value comprise instructions that cause the one or more processors to determine a sum of the purchase amounts indicated by entries of the future purchase data that indicate purchase dates within the future time period.
